(19) United States
(12) Patent Application Publication
(10) Pub. No.: US 2012/0092329 A1
(43) Pub. Date: Apr. 19, 2012

(54) TEXT-BASED 3D AUGMENTED REALITY

(75) Inventors: Hyung-Il Koo, Seoul (KR); Te-Won Lee, Seoul (KR); Kisun You, Seoul (KR); Young-Ki Baik, Seoul (KR)

(73) Assignee: QUALCOMM INCORPORATED, San Diego, CA (US)

(21) Appl. No.: 13/170,758

(22) Filed: Jun. 28, 2011

Related U.S. Application Data
(60) Provisional application No. 61/432,463, filed on Jan. 13, 2011.
(60) Provisional application No. 61/392,590, filed on Oct. 13, 2010.

(51) Int. Cl. G09G 5/00; G06T 15/00

(52) U.S. Cl. 345/419; 345/633

(57) ABSTRACT

A particular method includes receiving image data from an image capture device and detecting text within the image data. In response to detecting the text, augmented image data is generated that includes at least one augmented reality feature associated with the text.

### I. CLAIM OF PRIORITY

The present application claims priority from U.S. Provisional Patent Application No. 61/392,590 filed on Oct. 13, 2010 and U.S. Provisional Patent Application No. 61/432,463 filed on Jan. 13, 2011, the contents of each of which are expressly incorporated herein by reference in their entirety.

### II. FIELD

The present disclosure is generally related to image processing.

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet Protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player.

### IV. SUMMARY

A text-based augmented reality (AR) technique is described. The text-based AR technique can be used to retrieve information from text occurring in real world scenes and to show related content by embedding the related content into the real scene. For example, a portable device with a camera and a display screen can perform text-based AR to detect text occurring in a scene captured by the camera and to locate three-dimensional (3D) content associated with the text. The 3D content can be embedded with image data from the camera to appear as part of the scene when displayed, such as when displayed at the screen in an image preview mode. A user of the device may interact with the 3D content via an input device such as a touch screen or keyboard.

In a particular embodiment, a method includes receiving image data from an image capture device and detecting text within the image data. The method also includes, in response to detecting the text, generating augmented image data that includes at least one augmented reality feature associated with the text.

In another particular embodiment, an apparatus includes a text detector configured to detect text within image data received from an image capture device. The apparatus also includes a renderer configured to generate augmented image data. The augmented image data includes augmented reality data to render at least one augmented reality feature associated with the text.

Particular advantages provided by at least one of the disclosed embodiments include the ability to present the AR content in any scene based on the detected text in the scene, as compared to providing AR content in a limited number of scenes based on identifying pre-determined markers within the scene or identifying a scene based on natural images that are registered in a database.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1A is a block diagram to illustrate a particular embodiment of a system to provide text-based three-dimensional (3D) augmented reality (AR);

FIG. 1B is a block diagram to illustrate a first embodiment of an image processing device of the system of FIG. 1A;

FIG. 1C is a block diagram to illustrate a second embodiment of an image processing device of the system of FIG. 1A;

FIG. 1D is a block diagram to illustrate a particular embodiment of a text detector of the system of FIG. 1A and a particular embodiment of a text recognizer of the text detector;

FIG. 2 is a diagram depicting an illustrative example of text detection within an image that may be performed by the system of FIG. 1A;

FIG. 3 is a diagram depicting an illustrative example of text orientation detection that may be performed by the system of FIG. 1A;

FIG. 4 is a diagram depicting an illustrative example of text region detection that may be performed by the system of FIG. 1A;

FIG. 5 is a diagram depicting an illustrative example of text region detection that may be performed by the system of FIG. 1A;

FIG. 6 is a diagram depicting an illustrative example of text region detection that may be performed by the system of FIG. 1A;

FIG. 7 is a diagram depicting an illustrative example of a detected text region within the image of FIG. 2;

FIG. 8 is a diagram depicting text from a detected text region after perspective distortion removal;

FIG. 9 is a diagram illustrating a particular embodiment of a text verification process that may be performed by the system of FIG. 1A;

FIG. 10 is a diagram depicting an illustrative example of text region tracking that may be performed by the system of FIG. 1A;

FIG. 11 is a diagram depicting an illustrative example of text region tracking that may be performed by the system of FIG. 1A;

FIG. 12 is a diagram depicting an illustrative example of text region tracking that may be performed by the system of FIG. 1A;

FIG. 13 is a diagram depicting an illustrative example of text region tracking that may be performed by the system of FIG. 1A;

FIG. 14 is a diagram depicting an illustrative example of determining a camera pose based on text region tracking that may be performed by the system of FIG. 1A;

FIG. 15 is a diagram depicting an illustrative example of text region tracking that may be performed by the system of FIG. 1A;

FIG. 16 is a diagram depicting an illustrative example of text-based three-dimensional (3D) augmented reality (AR) content that may be generated by the system of FIG. 1A;

FIG. 17 is a flow diagram to illustrate a first particular embodiment of a method of providing text-based three-dimensional (3D) augmented reality (AR);

FIG. 18 is a flow diagram to illustrate a particular embodiment of a method of tracking text in image data;

FIG. 19 is a flow diagram to illustrate a particular embodiment of a method of tracking text in multiple frames of image data;

FIG. 20 is a flow diagram to illustrate a particular embodiment of a method of estimating a pose of an image capture device;

FIG. 21A is a flow diagram to illustrate a second particular embodiment of a method of providing text-based three-dimensional (3D) augmented reality (AR);

FIG. 21B is a flow diagram to illustrate a third particular embodiment of a method of providing text-based three-dimensional (3D) augmented reality (AR);

FIG. 21C is a flow diagram to illustrate a fourth particular embodiment of a method of providing text-based three-dimensional (3D) augmented reality (AR); and

FIG. 21D is a flow diagram to illustrate a fifth particular embodiment of a method of providing text-based three-dimensional (3D) augmented reality (AR).

### VI. DETAILED DESCRIPTION

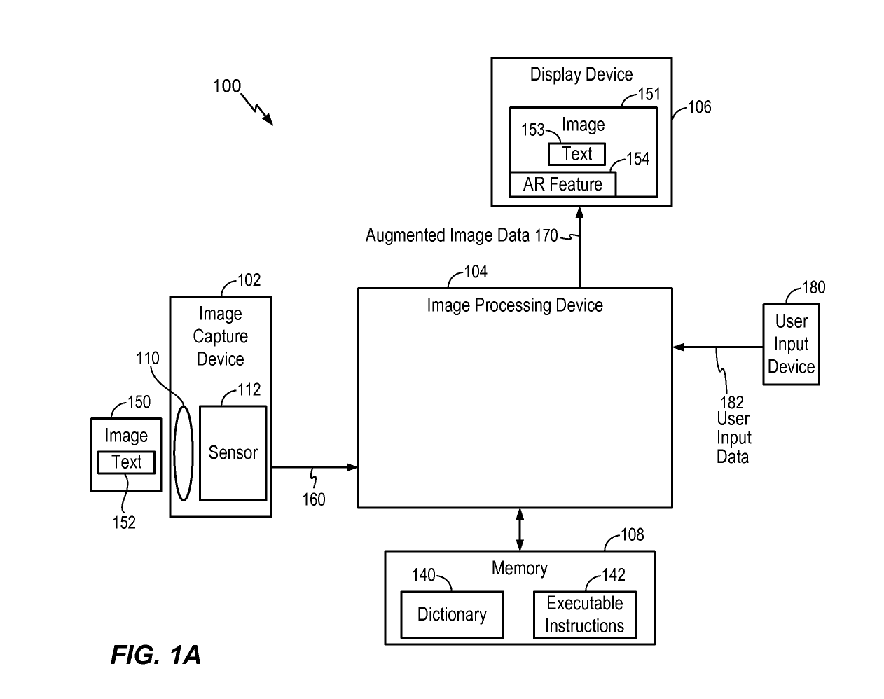

FIG. 1A is a block diagram of a particular embodiment of a system 100 to provide text-based three-dimensional (3D) augmented reality (AR). The system 100 includes an image capture device 102 coupled to an image processing device 104. The image processing device 104 is also coupled to a display device 106, a memory 108, and a user input device 180. The image processing device 104 is configured to detect text in incoming image data or video data and generate 3D AR data for display.

In a particular embodiment, the image capture device 102 includes a lens 110 configured to direct incoming light representing an image 150 of a scene with text 152 to an image sensor 112. The image sensor 112 may be configured to generate video or image data 160 based on detected incoming light. The image capture device 102 may include one or more digital still cameras, one or more video cameras, or any combination thereof.

In a particular embodiment, the image processing device 104 is configured to detect text in the incoming video/image data 160 and generate augmented image data 170 for display, as described with respect to FIGS. 1B, 1C, and 1D. The image capture device 104 is configured to detect text within the video/image data 160 received from the image capture device 102. The image capture device 104 is configured to generate augmented reality (AR) data and camera pose data based on the detected text. The AR data includes at least one augmented reality feature, such as an AR feature 154, to be combined with the video/image data 160 and displayed as embedded within an augmented image 151. The image capture device 104 embeds the AR data in the video/image data 160 based on the camera pose data to generate the augmented image data 170 that is provided to the display device 106.

In a particular embodiment, the display device 106 is configured to display the augmented image data 170. For example, the display device 106 may include an image preview screen or other visual display device. In a particular embodiment, the user input device 180 enables user control of the three-dimensional object displayed at the display device 106. For example, the user input device 180 may include one or more physical controls, such as one or more switches, buttons, joysticks, or keys. As other examples, the user input device 180 can include a touchscreen of the display device 106, a speech interface, an echolocator or gesture recognizer, another user input mechanism, or any combination thereof.

In a particular embodiment, at least a portion of the image processing device 104 may be implemented via dedicated circuitry. In other embodiments, at least a portion of the image processing device 104 may be implemented by execution of computer executable code that is executed by the image processing device 104. To illustrate, the memory 108 may include a non-transitory computer readable storage medium storing program instructions 142 that are executable by the image processing device 104. The program instructions 142 may include code for detecting text within image data received from an image capture device, such as text within the video/image data 160, and code for generating augmented image data. The augmented image data includes augmented reality data to render at least one augmented reality feature associated with the text, such as the augmented image data 170.

A method for text-based AR may be performed by the image processing device 104 of FIG. 1A. Text-based AR means a technique to (a) retrieve information from the text in real world scenes and (b) show the related content by embedding the related content in the real scene. Unlike marker based AR, this approach does not require pre-defined markers, and it can use existing dictionaries (English, Korean, Wikipedia, . . . ). Also, by showing the results in a variety of forms (overlaid text, images, 3D objects, speech, and/or animations), text-based AR can be very useful to many applications (e.g., tourism, education).

A particular illustrative embodiment of a use case is a restaurant menu. When traveling in a foreign country, a traveler might see foreign words which the traveler may not be able to look up in a dictionary. Also, it may be difficult to understand a meaning of the foreign words even if the foreign words are found in the dictionary.

For example, “Jajangmyeon” is a popular Korean dish, derived from the Chinese dish “Zha jjang mian”. It consists of wheat noodles topped with a thick sauce made of Chunjang (a salty black soybean paste), diced meat and vegetables, and sometimes also seafood. Although this explanation is helpful, it is still difficult to know whether the dish would be satisfying to an individual's taste or not. However, it would be easier for an individual to understand Jajangmyeon if the individual can see an image of a prepared dish of Jajangmyeon.

If 3D information of Jajangmyeon were available, the individual could see its various shapes and then have a much better understanding of Jajangmyeon. Text-based 3D AR system can help to understand a foreign word from its 3D information.

In a particular embodiment, text-based 3D AR includes performing text region detection. A text region may be detected within a ROI (region of interest) around a center of an image by using binarization and projection profile analysis. For example, binarization and projection profile analysis may be performed by a text recognition detector, such as a text region detector 122 as described with respect to FIG. 1D.

FIG. 1B is a block diagram of a first embodiment of the image processing device 104 of FIG. 1A that includes a text detector 120, a tracking/pose estimation module 130, an AR content generator 190, and a renderer 134. The image processing device 104 is configured to receive the incoming video/image data 160 and to selectively provide the video/image data 160 to the text detector 120 via operation of a switch 194 that is responsive to a mode of the image processing device 104. For example, in a detection mode the switch 194 may provide the video/image data 160 to the text detector 120, and in a tracking mode the switch 194 may cause processing of the video/image data 160 to bypass the text detector 120. The mode may be indicated to the switch 194 via a detection/tracking mode indicator 172 provided by the tracking/pose estimation module 130.

The text detector 120 is configured to detect text within image data received from the image capture device 102. The text detector 120 may be configured to detect text of the video/image data 160 without examining the video/image data 160 to locate predetermined markers and without accessing a database of registered natural images. The text detector 120 is configured to generate verified text data 166 and text region data 167, as described with respect to FIG. 1D.

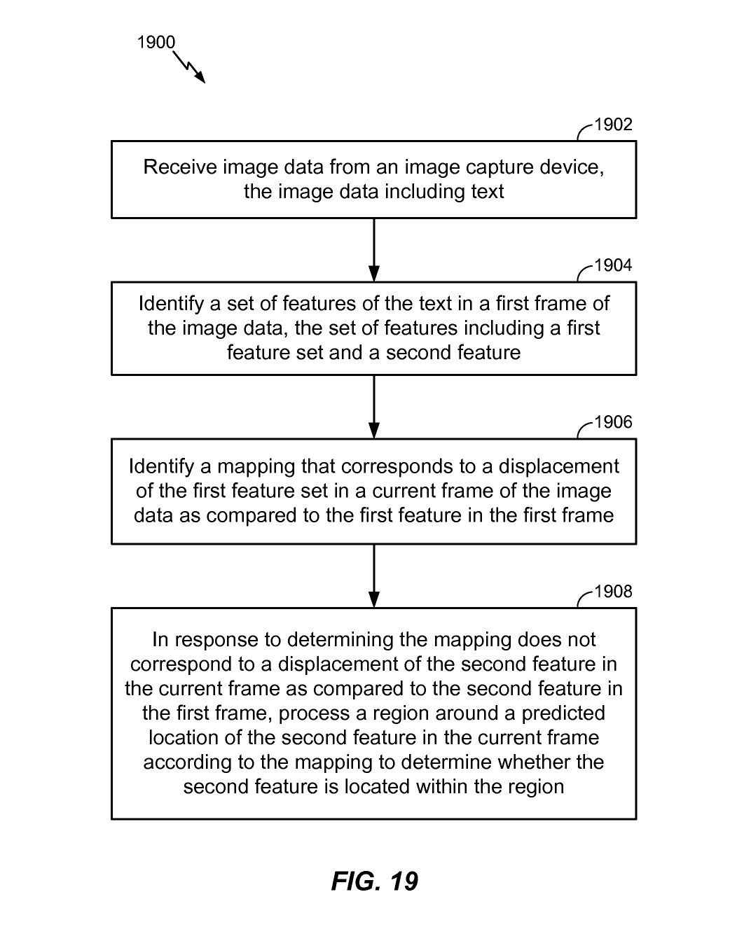

In a particular embodiment, the AR content generator 190 is configured to receive the verified text data 166 and to generate augmented reality (AR) data 192 that includes at least one augmented reality feature, such as the AR feature 154, to be combined with the video/image data 160 and displayed as embedded within the augmented image 151. For example, the AR content generator 190 may select one or more augmented reality features based on a meaning, translation, or other aspect of the verified text data 166, such as described with respect to a menu translation use case that is illustrated in FIG. 16. In a particular embodiment, the at least one augmented reality feature is a three-dimensional object.

In a particular embodiment, the tracking/pose estimation module 130 includes a tracking component 131 and a pose estimation component 132. The tracking/pose estimation module 130 is configured to receive the text region data 167 and the video/image data 160. The tracking component 131 of the tracking/pose estimation module 130 may be configured to track a text region relative to at least one other salient feature in the image 150 during multiple frames of the video data while in the tracking mode. The pose estimation component 132 of the tracking/pose estimation module 130 may be configured to determine a pose of the image capture device 102. The tracking/pose estimation module 130 is configured to generate camera pose data 168 based at least in part on the pose of the image capture device 102 determined by the pose estimation component 132. The text region may be tracked in three dimensions and the AR data 192 may be positioned in the multiple frames according to a position of the tracked text region and the pose of the image capture device 102.

In a particular embodiment, the renderer 134 is configured to receive the AR data 192 from the AR content generator 190 and camera pose data 168 from the tracking/pose estimation module 130 and to generate the augmented image data 170. The augmented image data 170 may include augmented reality data to render at least one augmented reality feature associated with the text, such as the augmented reality feature 154 associated with the text 152 of the original image 150 and text 153 of the augmented image 151. The renderer 134 may also be responsive to user input data 182 received from the user input device 180 to control presentation of the AR data 192.

In a particular embodiment, at least a portion of one or more of the text detector 120, the AR content generator 190, the tracking/pose estimation module 130, and the renderer 134 may be implemented via dedicated circuitry. In other embodiments, one or more of the text detector 120, the AR content generator 190, the tracking/pose estimation module 130, and the renderer 134 may be implemented by execution of computer executable code that is executed by a processor 136 included in the image processing device 104. To illustrate, the memory 108 may include a non-transitory computer readable storage medium storing program instructions 142 that are executable by the processor 136. The program instructions 142 may include code for detecting text within image data received from an image capture device, such as text within the video/image data 160, and code for generating the augmented image data 170. The augmented image data 170 includes augmented reality data to render at least one augmented reality feature associated with the text.

During operation, the video/image data 160 may be received as frames of video data that include data representing the image 150. The image processing device 104 may provide the video/image data 160 to the text detector 120 in a text detection mode. The text 152 may be located and the verified text data 166 and the text region data 167 may be generated. The AR data 192 is embedded in the video/image data 160 by the renderer 134 based on the camera pose data 168, and the augmented image data 170 is provided to the display device 106.

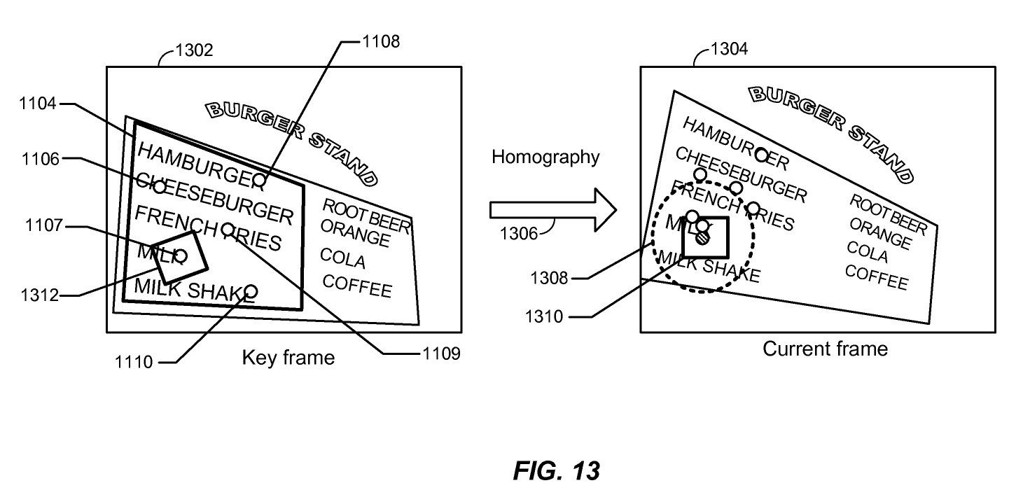

In response to detecting the text 152 in a text detection mode, the image processing device 104 may enter a tracking mode. In the tracking mode, the text detector 120 may be bypassed and the text region may be tracked based on determining motion of points of interest between successive frames of the video/image data 160, as described with respect to FIGS. 10-15. In the event the text region tracking indicates that the text region is no longer in the scene, the detection/tracking mode indicator 172 may be set to indicate the detection mode and text detection may be initiated at the text detector 120. Text detection may include text region detection, text recognition, or a combination thereof, such as described with respect to FIG. 1D.

FIG. 1C is a block diagram of a second embodiment of the image processing device 104 of FIG. 1A that includes the text detector 120, the tracking/pose estimation module 130, the AR content generator 190, and the renderer 134. The image processing device 104 is configured to receive the incoming video/image data 160 and to provide the video/image data 160 to the text detector 120. In contrast to FIG. 1B, the image processing device 104 depicted in FIG. 1C may perform text detection in every frame of the incoming video/image data 160 and does not transition between a detection mode and a tracking mode.

FIG. 1D is a block diagram of a particular embodiment of the text decoder 120 of the image processing device 104 of FIGS. 1B and 1C. The text detector 120 is configured to detect text within the video/image data 160 received from the image capture device 102. The text detector 120 may be configured to detect text in incoming image data without examining the video/image data 160 to locate predetermined markers and without accessing a database of registered natural images. Text detection may include detecting a region of the text and recognition of text within the region. In a particular embodiment, the text detector 120 includes a text region detector 122 and a text recognizer 125. The video/image data 160 may be provided to the text region detector 122 and the text recognizer 125.

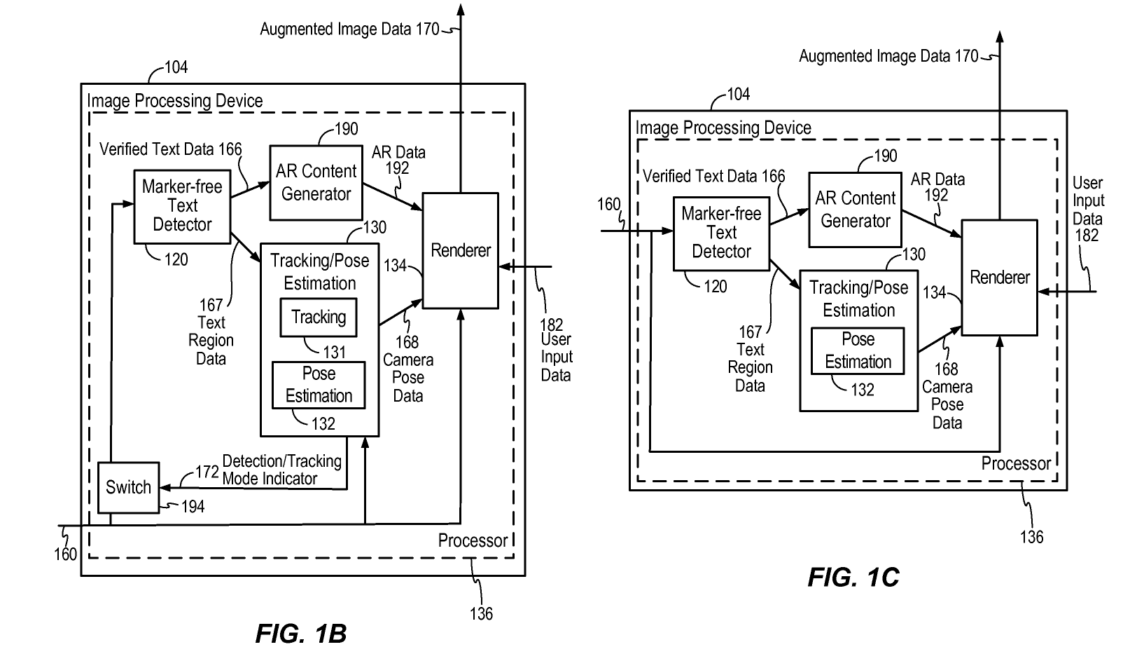

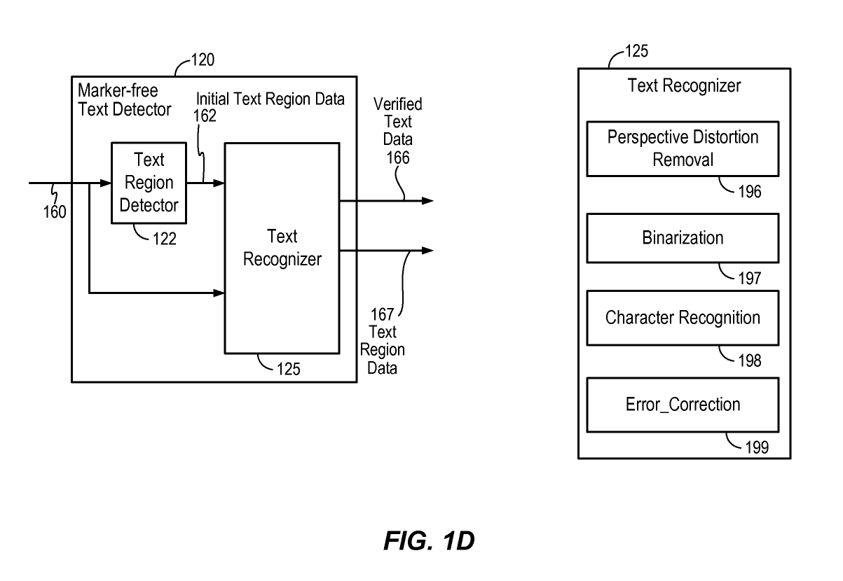

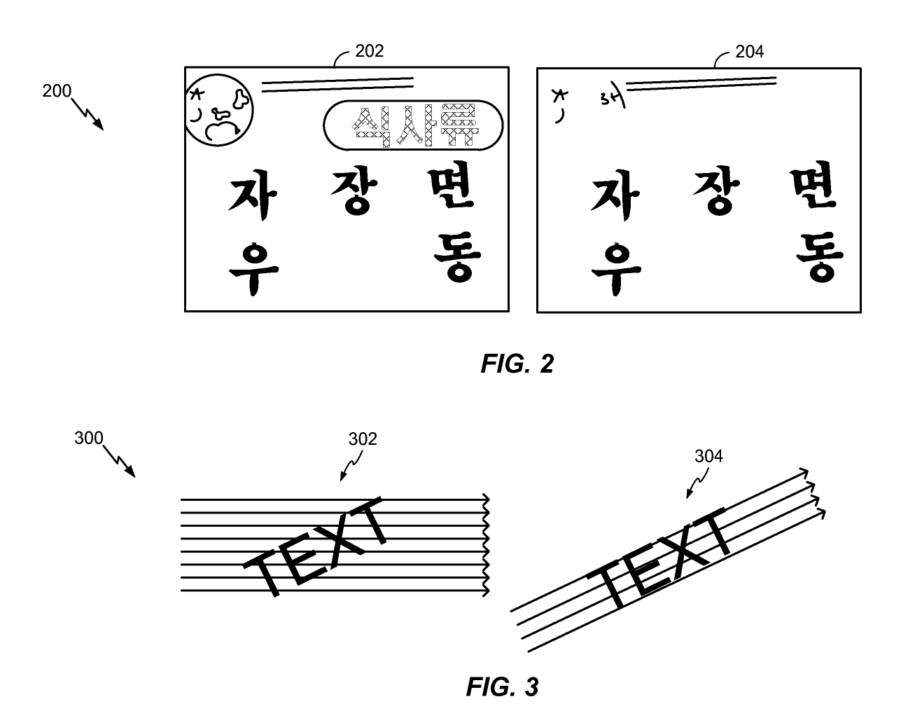

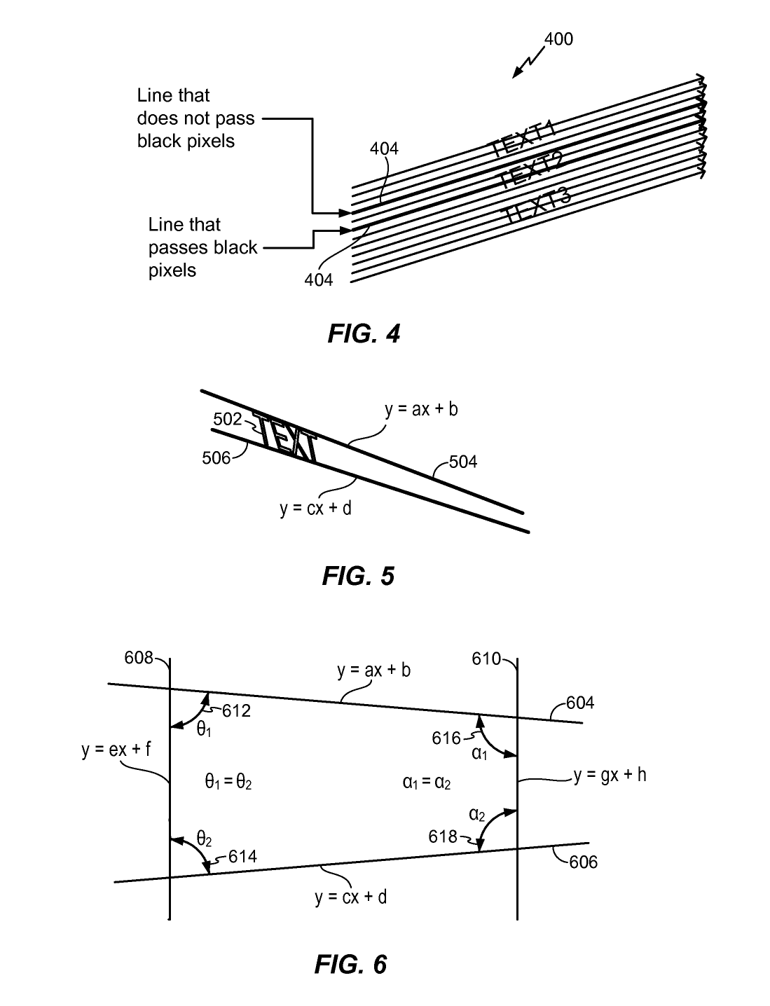

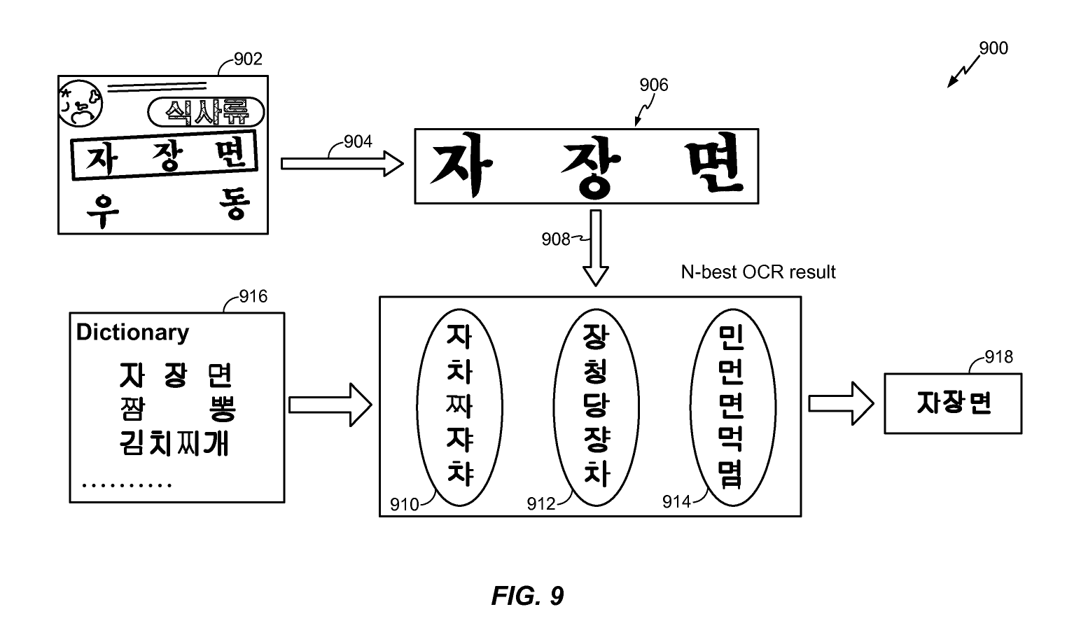

The text region detector 122 is configured to locate a text region within the video/image data 160. For example, the text region detector 122 may be configured to search a region of interest around a center of an image and may locate a text region using a binarization technique, as described with respect to FIG. 2. The text region detector 122 may be configured to estimate an orientation of a text region, such as according to a projection profile analysis as described with respect to FIGS. 3-4 or bottom-up clustering methods. The text region detector 122 is configured to provide initial text region data 162 indicating one or more detected text regions, such as described with respect to FIGS. 5-7. In a particular embodiment, the text region detector 122 may include a binarization component configured to perform a binarization technique, such as described with respect to FIG. 7.

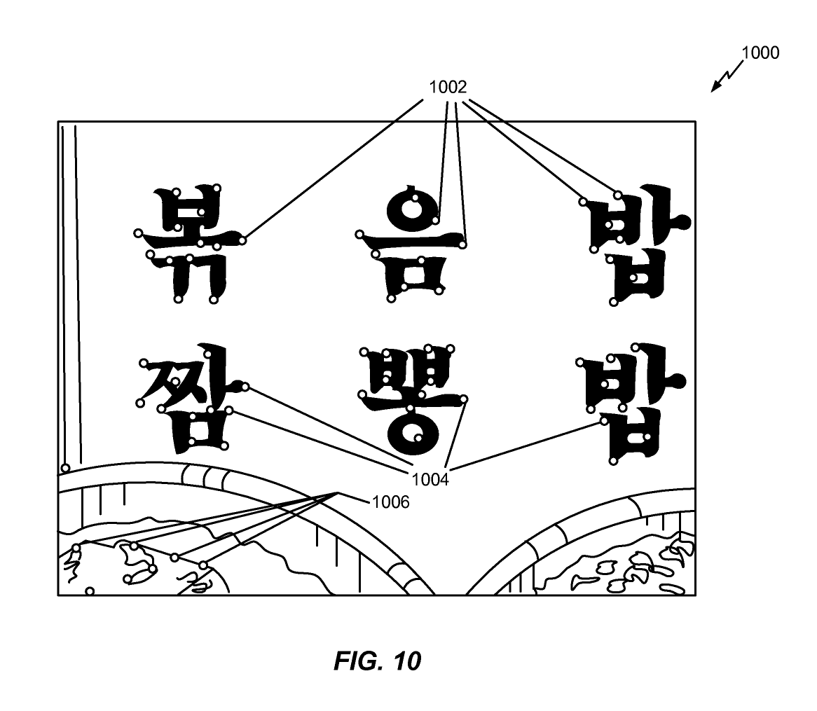

The text recognizer 125 is configured to receive the video/image data 160 and the initial text region data 162. The text recognizer 125 may be configured to adjust a text region identified in the initial text region data 162 to reduce a perspective distortion, such as described with respect to FIG. 8. For example, the text 152 may have a distortion due to a perspective of the image capture device 102. The text recognizer 125 may be configured to adjust the text region by applying a transform that maps corners of a bounding box of the text region into corners of a rectangle to generate proposed text data. The text recognizer 125 may be configured to generate the proposed text data via optical character recognition.

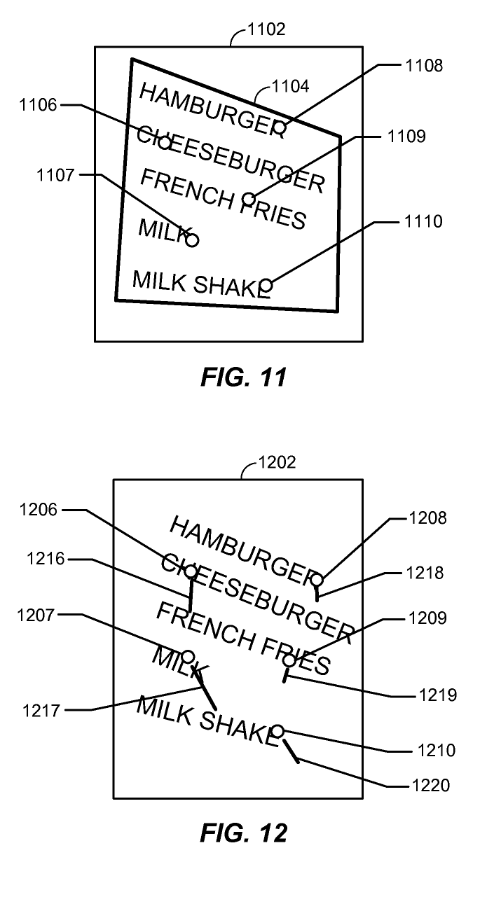

The text recognizer 125 may be further configured to access a dictionary to verify the proposed text data. For example, the text recognizer 125 may access one or more dictionaries stored in the memory 108 of FIG. 1A, such as a representative dictionary 140. The proposed text data may include multiple text candidates and confidence data associated with the multiple text candidates. The text recognizer 125 may be configured to select a text candidate corresponding to an entry of the dictionary 140 according to a confidence value associated with the text candidate, such as described with respect to FIG. 9. The text recognizer 125 is further configured to generate verified text data 166 and text region data 167. The verified text data 166 may be provided to the AR content generator 190 and the text region data 167 may be provided to the tracking/pose estimation 130, such as described in FIGS. 1B and 1C.

In a particular embodiment, the text recognizer 125 may include a perspective distortion removal component 196, a binarization component 197, a character recognition component 198, and an error_correction component 199. The perspective distortion removal component 196 is configured to reduce a perspective distortion, such as described with respect to FIG. 8. The binarization component 197 is configured to perform a binarization technique, such as described with respect to FIG. 7. The character recognition component 198 is configured to perform text recognition, such as described with respect to FIG. 9. The error_correction component 199 is configured to perform error correction, such as described with respect to FIG. 9.

Text-based AR that is enabled by the system 100 of FIG. 1A in accordance with one or more of the embodiments of FIGS. 1B, 1C, and 1D offers significant advantages over other AR schemes. For example, a marker-based AR scheme may include a library of “markers” that are distinct images that are relatively simple for a computer to identify in an image and to decode. To illustrate, a marker may resemble a two-dimensional bar code in both appearance and function, such as a Quick Response (QR) code. The marker may be designed to be readily detectable in an image and easily distinguished from other markers. When a marker is detected in an image, relevant information may be inserted over the marker. However, markers that are designed to be detectable look unnatural when embedded into a scene. In some marker scheme implementations, boundary markers may also be required to verify whether a designated marker is visible within a scene, further degrading a natural quality of a scene with additional markers.

Another drawback to marker-based AR schemes is that markers must be embedded in every scene in which augmented reality content is to be displayed. As a result, marker schemes are inefficient. Further, because markers must be pre-defined and inserted into scenes, marker-based AR schemes are relatively inflexible.

Text-based AR also provides benefits as compared to natural features-based AR schemes. For example, a natural features-based AR scheme may require a database of natural features. A scale-invariant feature transform (SIFT) algorithm may be used to search each target scene to determine if one or more of the natural features in the database is in the scene. Once enough similar natural features in the database are detected in the target scene, relevant information may be overlaid relative to the target scene. However, because such a natural features-based scheme may be based on entire images and there may be many targets to detect, a very large database may be required.

In contrast to such marker-based AR schemes and natural features-based AR schemes, embodiments of the text-based AR scheme of the present disclosure do not require prior modification of any scene to insert markers and also do not require a large database of images for comparison. Instead, text is located within a scene and relevant information is retrieved based on the located text.

Typically, text within a scene embodies important information about the scene. For example, text appearing in a movie poster frequently includes the title of the movie and may also include a tagline, movie release date, names of actors, directors, producers, or other relevant information. In a text-based AR system, a database (e.g., a dictionary) storing a small amount of information could be used to identify information relevant to a movie poster (e.g. movie title, names of actors/actresses). In contrast, a natural features-based AR scheme may require a database corresponding to thousands of different movie posters. In addition, a text-based AR system can be applied to any type of target scene because the text-based AR system identifies relevant information based on text detected within the scene, as opposed to a marker-based AR scheme that is only effective with scenes that have been previously modified to include a marker. Text-based AR can therefore provide superior flexibility and efficiency as compared to marker-based schemes and can also provide more detailed target detection and reduced database requirements as compared to natural features-based schemes.

FIG. 2 depicts an illustrative example 200 of text detection within an image. For example, the text detector 120 of FIG. 1D may perform binarization on an input frame of the video/image data 160 so that text becomes black and other image content becomes white. The left image 202 illustrates an input image and the right image 204 illustrates a binarization result of the input image 202. The left image 202 is representative of a color image or a color-scale image (e.g., gray-scale image). Any binarization method, such as adaptive threshold-based binarization methods or color-clustering based methods, may be implemented for robust binarization for camera-captured images.

FIG. 3 depicts an illustrative example 300 of text orientation detection that may be performed by the text detector 120 of FIG. 1D. Given the binarization result, a text orientation may be estimated by using projection profile analysis. A basic idea of projection profile analysis is that a “text region (black pixels)” can be covered with a smallest number of lines when the line direction coincides with text orientation. For example, a first number of lines having a first orientation 302 is greater than a second number of lines having a second orientation 304 that more closely matches an orientation of underlying text. By testing several directions, a text orientation may be estimated.

Given the orientation of text, a text region may be found. FIG. 4 depicts an illustrative example 400 of text region detection that may be performed by the text detector 120 of FIG. 1D. Some lines in FIG. 4, such as the representative line 404, are lines that do not pass black pixels (pixels in text), while other lines such as the representative line 406 are lines that cross black pixels. By finding the lines that do not pass black pixels, a vertical bound of a text region may be detected.

FIG. 5 is a diagram depicting an illustrative example of text region detection that may be performed by the system of FIG. 1A. The text region may be detected by determining a bounding box or bounding region associated with text 502. The bounding box may include a plurality of intersecting lines that substantially surround the text 502. For example, in order to find a relatively tight bounding box of a word of the text 502, an optimization problem may be arranged and solved. For purposed of addressing the optimization problem, pixels that form the text 502 may be denoted as {(xᵢ,yᵢ)}ᵢ₌₁^{N}. An upper line 504 of the bounding box may be described by a first equation y=ax+b, and a lower line 506 of the bounding box may be described by a second equation y=cx+d. To find values for the first and second equations, the following criterion may be imposed:

$${min}_{a , b , c , d} {\int }_{m}^{M} \vert ( ax + b ) - ( cx + d ) \vert d x$$

satisfying:

yᵢ≦axᵢ+b (i=1,2, . . . N)

yᵢ≧cxᵢ+d (i=1,2, . . . N)

where:

$$m = {min}_{1 \leq i \leq N} {x}_{i}$$

$$M = {max}_{1 \leq i \leq N} {x}_{i}$$

In a particular embodiment, this condition may intuitively indicate that the upper line 504 and the lower line 506 are determined in a manner that reduces (e.g., minimizes) the area between the lines 504, 506.

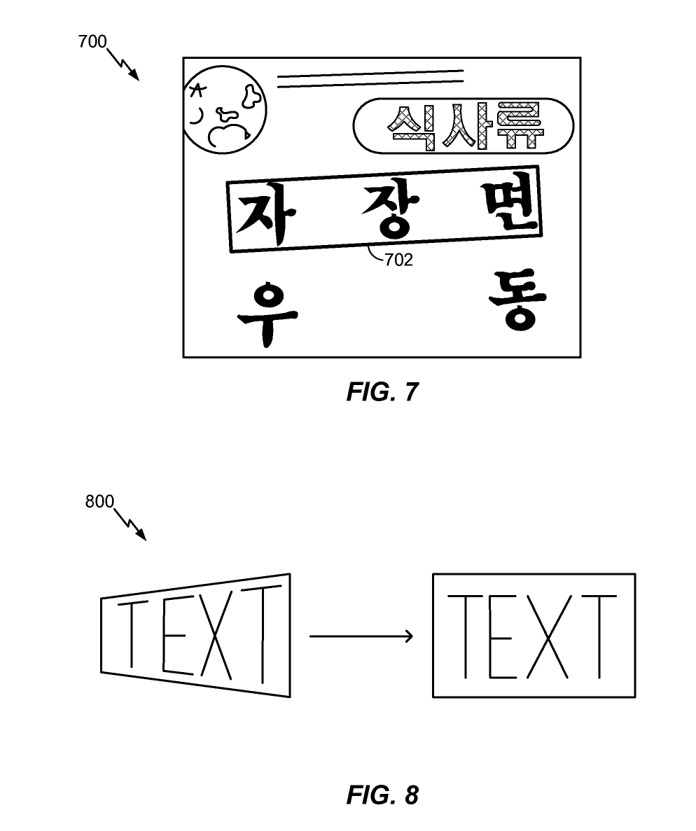

After vertical bounds of text have been detected (e.g., lines that at least partially distinguish upper and lower bounds of the text), horizontal bounds (e.g., lines that at least partially distinguish left and right bounds of the text) may also be detected. FIG. 6 is a diagram depicting an illustrative example of text region detection that may be performed by the system of FIG. 1A. FIG. 6 illustrates a method to find horizontal bounds (e.g., a left line 608 and a right line 610) to complete a bounding box after an upper line 604 and a lower line 606 have been found, such as by a method described with reference to FIG. 5.

The left line 608 may be described by a third equation y=ex+f, and the right line 610 may be described by a fourth equation y=gx+h. Since there may be a relatively small number of pixels on left and right sides of the bounding box, slopes of the left line 608 and the right line 610 may be fixed. For example, as shown in FIG. 6, a first angle 612 formed by the left line 608 and the top line 604 may be equal to a second angle 614 formed by the left line 608 and the bottom line 606. Likewise, a third angle 616 formed by the right line 610 and the top line 604 may be equal to a fourth angle 618 formed by the right line 610 and the bottom line 606. Note that an approach similar to that used to find the top line 604 and the bottom line 606 may be used to find the lines 608, 610; however, this approach may cause the slopes of lines 608, 610 to be unstable.

The bounding box or bounding region may correspond to a distorted boundary region that at least partially corresponds to a perspective distortion of a regular bounding region. For example, the regular bounding region may be a rectangle that encloses text and that is distorted due to camera pose to result in the distorted boundary region illustrated in FIG. 6. By assuming the text is located on a planar object and has a rectangle bounding box, the camera pose can be determined based on one or more camera parameters. For example, the camera pose can be determined at least partially based on a focal length, principal point, skew coefficient, image distortion coefficients (such as radial and tangential distortions), one or more other parameters, or any combination thereof.

The bounding box or bounding region described with reference to FIGS. 4-6 has been described with reference to top, bottom, left and right lines, as well as to horizontal and vertical lines or boundaries merely for the convenience of the reader. The methods described with reference to FIGS. 4-6 are not limited to finding boundaries for text that is arranged horizontally or vertically. Further, the methods described with reference to FIGS. 4-6 may be used or adapted to find boundary regions associated with text that is not readily bounded by straight lines, e.g., text that is arranged in a curved manner.

FIG. 7 depicts an illustrative example 700 of a detected text region 702 within the image of FIG. 2. In a particular embodiment, text-based 3D AR includes performing text recognition. For example, after detecting a text region, the text region may be rectified so that one or more distortions of text due to perspective are removed or reduced. For example, the text recognizer 125 of FIG. 1D may rectify a text region indicated by the initial text region data 162. A transform may be determined that maps four corners of a bounding box of a text region into four corners of a rectangle. A focal length of a lens (such as is commonly available in consumer cameras) may be used to remove perspective distortions. Alternatively, an aspect ratio of camera captured images may be used (if a scene is captured perpendicular, there may not be a large difference between the approaches).

FIG. 8 depicts an example 800 of adjusting a text region including “TEXT” using perspective distortion removal to reduce a perspective distortion. For example, adjusting the text region may include applying a transform that maps corners of a bounding box of the text region into corners of a rectangle. In the example 800 depicted in FIG. 8, “TEXT” may be the text from the detected text region 702 of FIG. 7.

For the recognition of rectified characters, one or more optical character recognition (OCR) techniques may be applied. Because conventional OCR methods may be designed for use with scanned images instead of camera images, such conventional methods may not sufficiently handle appearance distortion in images captured by a user-operated camera (as opposed to a flat scanner). Training samples for camera-based OCR may be generated by combining several distortion models to handle appearance distortion effects, such as may be used by the text recognizer 125 of FIG. 1D.

In a particular embodiment, text-based 3D AR includes performing a dictionary lookup. OCR results may be erroneous and may be corrected by using dictionaries. For example, a general dictionary can be used. However, use of context information can assist in selection of a suitable dictionary that may be smaller than a general dictionary for faster lookup and more appropriate results. For example, using information that a user is in a Chinese restaurant in Korea enables selection of a dictionary that may consist of about 100 words.

In a particular embodiment, an OCR engine (e.g., the text recognizer 125 of FIG. 1D) may return several candidates for each character and data indicating a confidence value associated with each of the candidates. FIG. 9 depicts an example 900 of a text verification process. Text from a detected text region within an image 902 may undergo a perspective distortion removal operation 904 to result in rectified text 906. An OCR process may return five most likely candidates for each character, illustrated as a first group 910 corresponding to a first character, a second group 912 corresponding to a second character, and a third group 914 corresponding to a third character.

For example, the first character is “ [symbol] ” in the binarized result and several candidates (e.g., ‘ [symbol] ’, ‘ [symbol] ’, ‘ [symbol] ’, ‘ [symbol] ’, ‘ [symbol] ’) are returned according to their confidence (illustrated as ranked according to a vertical position within the group 910, from a highest confidence value at top to a lowest confidence value at bottom).

A lookup operation at a dictionary 916 may be performed. In the example of FIG. 9, five candidates for each character results in 125 (=5*5*5) candidates words (e.g., “ [symbol] ”, “ [symbol] ”, “ [symbol] ”, . . . “ [symbol] ”). A lookup process may be performed to find a corresponding word in the dictionary 916 for one or more of the candidate words. For example, when multiple candidate words may be found in the dictionary 916, the verified candidate word 918 may be determined according to a confidence value (e.g., the candidate word that has a highest confidence value of those candidate words that are found in the dictionary).

In a particular embodiment, text-based 3D AR includes performing tracking and pose estimation. For example, in a preview mode of a portable electronic device (e.g., the system 100 of FIG. 1A), there may be around 15-30 images per second. Applying text region detection and text recognition on every frame is time consuming and may strain processing resources of a mobile device. Text region detection and text recognition for every frame may sometimes result in a visible flickering effect if some images in the preview video are recognized correctly.

A tracking method can include extracting interest points and computing motions of the interest points between consecutive images. By analyzing the computed motions, a geometric relation between real plane (e.g., a menu plate in the real world) and captured images may be estimated. A 3D pose of the camera can be estimated from the estimated geometry.

FIG. 10 depicts an illustrative example of text region tracking that may be performed by the tracking/pose estimation module 130 of FIG. 1B. A first set of representative interest points 1002 correspond to the detected text region. A second set of representative interest points 1004 correspond to salient features within a same plane as the detected text region (e.g., on a same face of a menu board). A third set of representative points 1006 correspond to other salient features within the scene, such as a bowl in front of a menu board.

In a particular embodiment, text tracking in text-based 3D AR differs from conventional techniques because (a) the text may be tracked in text-based 3D AR based on corner points, which provides robust object tracking, (b) salient features in the same plane may also be used in text-based 3D AR (e.g., not only salient features in a text box but also salient features in surrounding regions, such as the second set of representative interest points 1004), and (c) salient features are updated so that unreliable ones are discarded and new salient features are added. Hence, text tracking in text-based 3D AR, such as performed at the tracking/pose estimation module 130 of FIG. 1B, can be robust to viewpoint change and camera motion.

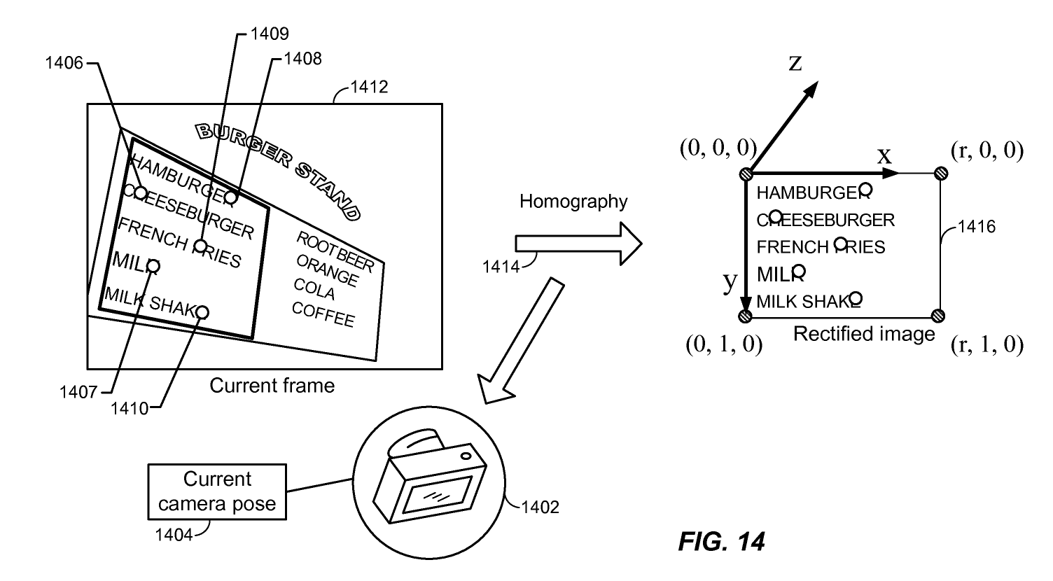

A 3D AR system may operate on real-time video frames. In real-time video, an implementation that performs text detection in every frame may produce unreliable results such as flickering artifacts. Reliability and performance may be improved by tracking detected text. Operation of a tracking module, such as the tracking/pose estimation module 130 of FIG. 1B, may include initialization, tracking, camera pose estimation, and evaluating stopping criteria. Examples of tracking operation are described with respect to FIGS. 11-15.

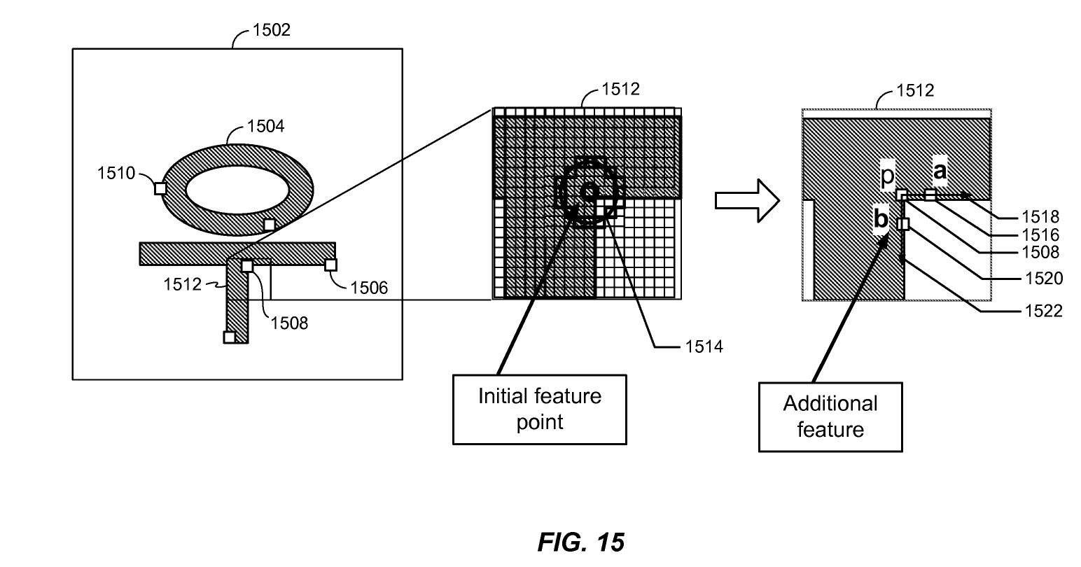

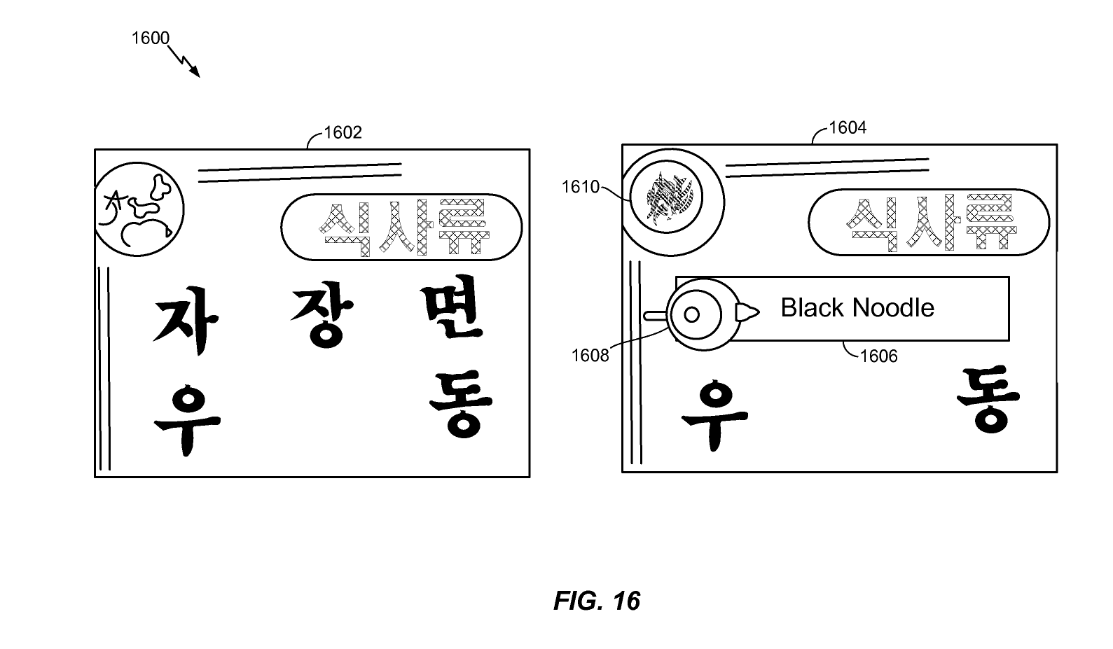

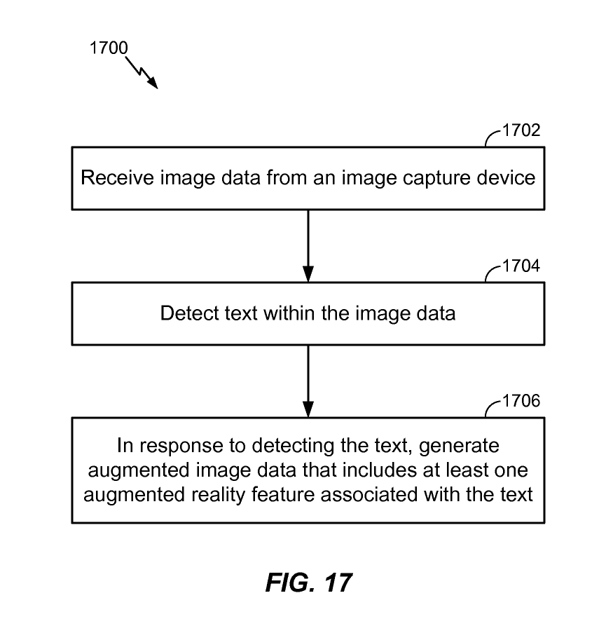

During initialization, the tracking module may be started with some information from a detection module, such as the text detector 120 of FIG. 1B. The initial information may include a detected text region and initial camera pose. For tracking, salient features such as a corner, line, blob, or other feature may be used as additional information. Tracking may include first using an optical-flow-based method to compute motion vectors of an extracted salient feature, as described in FIGS. 11-12. Salient features may be modified to an applicable form for the optical-flow-based method. Some salient features may lose their correspondence during frame-to-frame matching. For salient features losing correspondence, the correspondence may be estimated using a recovery method, as described in FIG. 13. By combining the initial matches and the corrected matches, final motion vectors may be obtained. Camera pose estimation may be performed using the observed motion vectors under the planar object assumption. Detecting the camera pose enables natural embedding of a 3D object. Camera pose estimation and object embedding are described with respect to FIGS. 14 and 16. Stopping criteria may include stopping the tracking module in response to a number or count of correspondences of tracked salient features falling below a threshold. The detection module may be enabled to detect text in incoming video frames for subsequent tracking.

FIGS. 11 and 12 are diagrams illustrating a particular embodiment of text region tracking that may be performed by the system of FIG. 1A. FIG. 11 depicts a portion of a first image 1102 of a real world scene that has been captured by an image capture device, such as the image capture device 102 of FIG. 1A. A text region 1104 has been identified in the first image 1102. To facilitate determining the camera pose (e.g., the relative position of the image capture device and one or more elements of the real world scene) the text region may be assumed to be a rectangle. Additionally, points of interest 1106-1110 have been identified in the text region 1104. For example, the points of interest 1106-1110 may include features of the text, such as corners or other contours of the text, selected using a fast corner recognition technique.

The first image 1102 may be stored as a reference frame to enable tracking of the camera pose when an image processing system enters a tracking mode, as described with reference to FIG. 1B. After the camera pose changes, one or more subsequent images, such as a second image 1202, of the real world scene may be captured by the image capture device. Points of interest 1206-1210 may be identified in the second image 1202. For example, the points of interest 1106-1110 may be located by applying a corner detection filter to the first image 1102 and the points of interest 1206-1210 may be located by applying the same corner detection filter to the second image 1202. As illustrated, points of interests 1206, 1208, and 1210 of FIG. 12 correspond to points of interest 1106, 1108, and 1110 of FIG. 11, respectively. However, the point 1207 (a top of the letter “L”) does not correspond to the point 1107 (a center of the letter “K”) and the point 1209 (in the letter “R”) does not correspond to the point 1109 (in the letter As a result of the camera pose changing, the positions of the points of interest 1206, 1208, 1210 in the second image 1202 may be different than the positions of the corresponding points of interest 1106, 1108, 1110 in the first image 1102. Optical flow (e.g., a displacement or location difference between the positions of the points of interest 1106-1110 in the first image 1102 as compared to the positions of the points of interest 1206-1210 in the second image 1202) may be determined. The optical flow is illustrated in FIG. 12 by flow lines 1216-1220 corresponding to the points of interest 1206-1210, respectively, such as a first flow line 1216 associated with a location change of the first point of interest 1106/1206 in the second image 1202 as compared to the first image 1102. Rather than calculate the orientation of the text region in the second image 1202 (e.g., using techniques described with reference to FIGS. 3-6), the orientation of the text region in the second image 1202 may be estimated based on the optical flow. For example, the change in relative positions of the points of interest 1106-1110 may be used to estimate the orientation of dimensions of the text region.

In particular circumstances, distortions may be introduced in the second image 1202 that were not present in the first image 1102. For example, the change in the camera pose may introduce distortions. In addition, points of interest detected in the second image 1202 may not correspond to points of interest detected in the first image 1102, such as points 1107-1207 and the points 1109-1209. Statistical techniques (such as random sample consensus) may be used to identify one or more flow lines that are outliers relative to the remaining flow lines. For example, the flow line 1217 illustrated in FIG. 12 may be an outlier since it is significantly different from a mapping of the other flow lines. In another example, the flow line 1219 may be an outlier since it is also significantly different from a mapping of the other flow lines. Outliers may be identified via a random sample consensus, where a subset of samples (e.g., a subset of the points 1206-1210) is selected randomly or pseudo-randomly and a test mapping is determined that corresponds to the displacement of at least some of the selected samples (e.g., a mapping that corresponds to the optical flows 1216, 1218, 1220). Samples that are determined to not correspond to the mapping (e.g., the points 1207 and 1209) may be identified as outliers of the test mapping. Multiple test mappings may be determined and compared to identify a selected mapping. For example, the selected mapping may be the test mapping that results in a fewest number of outliers.

FIG. 13 depicts correction of outliers based on a window-matching approach. A key frame 1302 may be used as a reference frame for tracking points of interest and a text region in one or subsequent frames (i.e., one or more frames that are captured, received, and/or processed after the key frame), such as a current frame 1304. The example key frame 1302 includes the text region 1104 and points of interest 1106-1110 of FIG. 11. The point of interest 1107 may be detected in the current frame 1304 by examining windows of the current frame 1304, such as a window 1310, within a region 1308 around a predicted location of the point of interest 1107. For example, a homography 1306 between the key frame 1302 and the current frame 1304 may be estimated by a mapping that is based on non-outlier points, such as described with respect to FIGS. 11-12. Homography is a geometric transform between two planar objects, which may be represented by a real matrix (e.g., a 3×3 real matrix). Applying the mapping to the point of interest 1107 results in a predicted location of the point of interest within the current frame 1304. Windows (i.e., areas of image data) within the region 1308 may be searched to determine whether the point of interest is within the region 1308. For example, a similarity measure such as a normalized cross-correlation (NCC) may be used to compare a portion 1312 of the key frame 1302 to multiple portions of the current frame 1304 within the region 1308, such as the illustrated window 1310. NCC can be used as a robust similarity measure to compensate geometric deformation and illumination change. However, other similarity measures may also be used.

Salient features that have lost their correspondences, such as the points of interest 1107 and 1109, may therefore be recovered using a windows-matching approach. As a result, text region tracking without use of predefined markers may be provided that includes an initial estimation of displacements of points of interest (e.g., motion vectors) and window-matching to recover outliers. Frame-by-frame tracking may continue until tracking fails, such as when a number of tracked salient features maintaining their correspondence falls below a threshold due to a scene change, zoom, illumination change, or other factors. Because text may include fewer points of interests (e.g., fewer corners or other distinct features) than pre-defined or natural markers, recovery of outliers may improve tracking and enhance operation of a text-based AR system.

FIG. 14 illustrates estimation of a pose 1404 of an image capture device such as a camera 1402. A current frame 1412 corresponds to the image 1202 of FIG. 12 with points of interest 1406-1410 corresponding to the points of interest 1206-1210 after outliers that correspond to the points 1207 and 1209 are corrected by windows-based matching, as described in FIG. 13. The pose 1404 is determined based on a homography 1414 to a rectified image 1416 where the distorted boundary region (corresponding to the text region 1104 of the key frame 1302 of FIG. 13) is mapped to a planar regular bounding region. Although the regular bounding region is illustrated as rectangular, in other embodiments the regular bounding region may be triangular, square, circular, ellipsoidal, hexagonal, or any other regular shape.

The camera pose 1404 can be represented by a rigid body transformation composed of 3×3 rotation matrix R and 3×1 translation matrix T. Using (i) the internal parameters of camera and (ii) the homography between the text bounding box in the keyframe and a bonding box in the current frame, the pose can be estimated via following equations:

R₁=H₁′/∥H₁′∥

R₂=H₂′/λH₂′∥

R₃=R₁xR₂

T=2H_{3/}′(∥H₁′∥+∥H₂′∥)

Where each number 1, 2, 3 denotes the 1, 2, 3 column vector of target matrix, respectively, and H′ denotes the homography normalized by internal camera parameters. After estimating the camera pose 1404, 3D content may be embedded into the image so that the 3D content appears as a natural part of the scene.

Accuracy of tracking of the camera pose may be improved by having a sufficient number of points of interest and/or accurate optical flow results to process. When the number of points of interest that are available to process falls below a threshold number (e.g., as a result of too few points of interest being detected), additional points of interest may be identified.

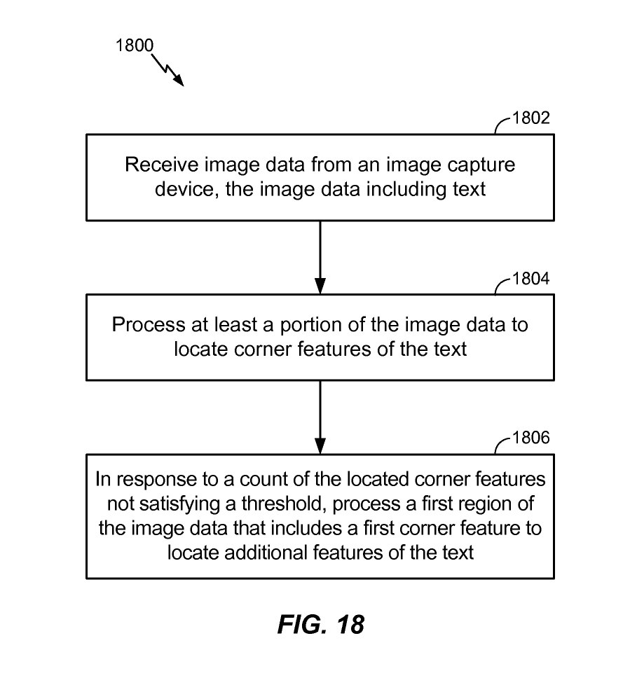

FIG. 15 is a diagram depicting an illustrative example of text region tracking that may be performed by the system of FIG. 1A. In particular, FIG. 15 illustrates a hybrid technique that may be used to identify points of interest in an image, such as the points of interest 1106-1110 of FIG. 11. FIG. 15 includes an image 1502 that includes a text character 1504. For ease of description, only a single text character 1504 is shown; however, the image 1502 could include any number of text characters.

A number of points of interest (indicated as boxes) of the text character 1504 are highlighted in FIG. 15. For example, a first point of interest 1506 is associated with an outside corner of the text character 1504, a second point of interest 1508 is associated with an inside corner of the text character 1504, and a third point of interest 1510 is associated with a curved portion of the text character 1504. The points of interest 1506-1510 may be identified by a corner detection process, such as by a fast corner detector. For example, the fast corner detector may identify corners by applying one or more filters to identify intersecting edges in the image. However, because corner points of text are often rare or unreliable, such as in rounded or curved characters, detected corner points may not be sufficient for robust text tracking.

An area 1512 around the second point of interest 1508 is enlarged to show details of the technique for identifying additional points of interest. The second point of interest 1508 may be identified as an intersection of two lines. For example, a set of pixels near the second point of interest 1508 may be checked to identify the two lines. A pixel value of a target or corner pixel p may be determined. To illustrate, the pixel value maybe a pixel intensity values or grayscale values. A threshold value, t, may be used to identify the lines from the target pixel. For example, edges of the lines may be differentiated by inspecting pixels in a ring 1514 around the corner p (the second point of interest 1508) to identify changing points between pixels that are darker than I(p)−t and pixels that are brighter than I(p)+t along the ring 1514, where I(p) denotes a intensity value of the position p. Changing points 1516 and 1520 may be identified where the edges that form the corner (p) 1508 intersect the ring 1514. A first line or position vector (a) 1518 may be identified as originating at the corner (p) 1508 and extending through the first changing point 1516. A second line or position vector (b) 1522 may be identified as originating at the corner (p) 1508 and extending through the second changing point 1520.

Weak corners (e.g., corners formed by lines intersecting to form approximately a 180 degree angle) may be eliminated. For example, by computing the inner product of the two lines, using an equation:

$$( \frac{( a - p )}{‖ a - p ‖} \cdot \frac{( b - p )}{‖ b - p ‖} ) = cos θ = v ,$$

where a, b and pεR² refer to inhomogeneous position vectors. Corners may be eliminated when v is lower than a threshold value. For example, a corner formed by two position vectors a, b may be eliminated as a tracking point when the angle between two vectors is about 180 degrees.

In a particular embodiment, homography of an image, H, is computed using only corners. For example, using:

x′=Hx

where x is a homogeneous position vectorεR³ in a key-frame (such as the key frame 1302 of FIG. 13) and x′ is a homogeneous position vectorεR³ of its corresponding point in a current frame (such as the current frame 1304 of FIG. 13).

In another particular embodiment, the homography of the image, H, is computed using corners and other features, such as lines. For example, H may be computed using:

x′=Hx

l^{T}=l′^{T}H

Where l is a line feature in a key-frame, and l′ is its corresponding line feature in a current frame.

A particular technique may use template matching via hybrid features. For example, window-based correlation methods (normalized cross-correlation (NCC), sum of squared differences (SSD), sum of absolute differences (SAD), etc.) may be used as cost functions, using:

Cost=−COR(x,x′)

The cost function may indicate similarity between a block (in a key-frame) around x and a block (in a current frame) around x′.

However, accuracy may be improved by using a cost function that includes geometric information of additional salient features such as the line (a) 1518 and the line (b) 1522 identified in FIG. 15, as an illustrative example, as:

Cost=α(d(l₁,H^{T}l₁′)+d(l₂,H^{T}l₂′))−β·COR(x,x′)

In some embodiments, additional salient features (i.e., non-corner features, such as lines) may be used for text tracking when few corners are available for tracking, such as when a number of detected corners in a key frame is less than a threshold number of corners. In other embodiments, the additional salient features may always be used. In some implementations the additional salient features may be lines, while in other implementations the additional salient features may include circles, contours, one or more other features, or any combination thereof.

Because the text, the 3D position of the text, and the camera pose information are known or estimated, content can be provided to users in a realistic manner. The content can be 3D objects that can be placed naturally. For example, FIG. 16 depicts an illustrative example 1600 of text-based three-dimensional (3D) augmented reality (AR) content that may be generated by the system of FIG. 1A. An image or video frame 1602 from a camera is processed and an augmented image or video frame 1604 is generated for display. The augmented frame 1604 includes the video frame 1602 with the text located in the center of the image replaced with an English translation 1606, a three-dimensional object 1608 placed on the surface of the menu plate (illustrated as a teapot) and an image 1610 of the prepared dish corresponding to detected text is shown in an upper corner. One or more of the augmented features 1606, 1608, 1610 may be available for user interaction or control via a user interface, such as via the user input device 180 of FIG. 1A.

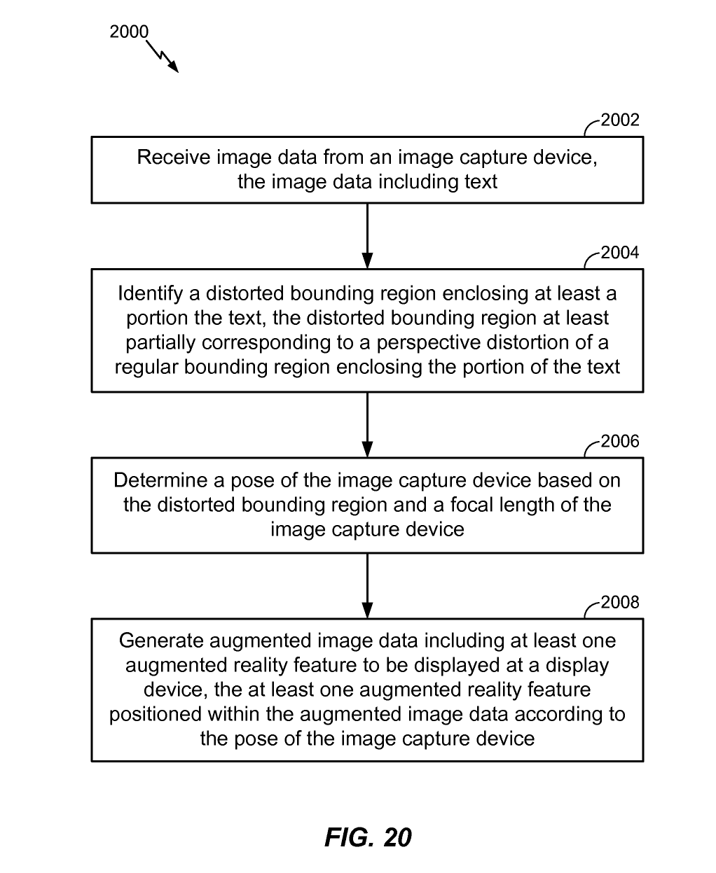

FIG. 17 is a flow diagram to illustrate a first particular embodiment of a method 1700 of providing text-based three-dimensional (3D) augmented reality (AR). In a particular embodiment, the method 1700 may be performed by the image processing device 104 of FIG. 1A.

Image data may be received from an image capture device, at 1702. For example, the image capture device may include a video camera of a portable electronic device. To illustrate, video/image data 160 is received at the image processing device 104 from the image capture device 102 of FIG. 1A.

Text may be detected within the image data, at 1704. The text may be detected without examining the image data to locate predetermined markers and without accessing a database of registered natural images. Detecting the text may include estimating an orientation of a text region according to a projection profile analysis, such as described with respect to FIGS. 3-4 or bottom-up clustering methods. Detecting the text may include determining a bounding region (or bounding box) enclosing at least a portion of the text, such as described with reference to FIGS. 5-7.

Detecting the text may include adjusting a text region to reduce a perspective distortion, such as described with respect to FIG. 8. For example, adjusting the text region may include applying a transform that maps corners of a bounding box of the text region into corners of a rectangle.

Detecting the text may include generating proposed text data via optical character recognition and accessing a dictionary to verify the proposed text data. The proposed text data may include multiple text candidates and confidence data associated with the multiple text candidates. A text candidate corresponding to an entry of the dictionary may be selected as verified text according to a confidence value associated with the text candidate, such as described with respect to FIG. 9.

In response to detecting the text, augmented image data may be generated that includes at least one augmented reality feature associated with the text, at 1706. The at least one augmented reality feature may be incorporated within the image data, such as the augmented reality features 1606 and 1608 of FIG. 16. The augmented image data may be displayed at a display device of the portable electronic device, such as the display device 106 of FIG. 1A.

In a particular embodiment, the image data may correspond to a frame of video data that includes the image data and in response to detecting the text, a transition may be performed from a text detection mode to a tracking mode. A text region may be tracked in the tracking mode relative to at least one other salient feature of the video data during multiple frames of the video data, such as described with reference to FIGS. 10-15. In a particular embodiment, a pose of the image capture device is determined and the text region is tracked in three dimensions, such as described with reference to FIG. 14. The augmented image data is positioned in the multiple frames according to a position of the text region and the pose.

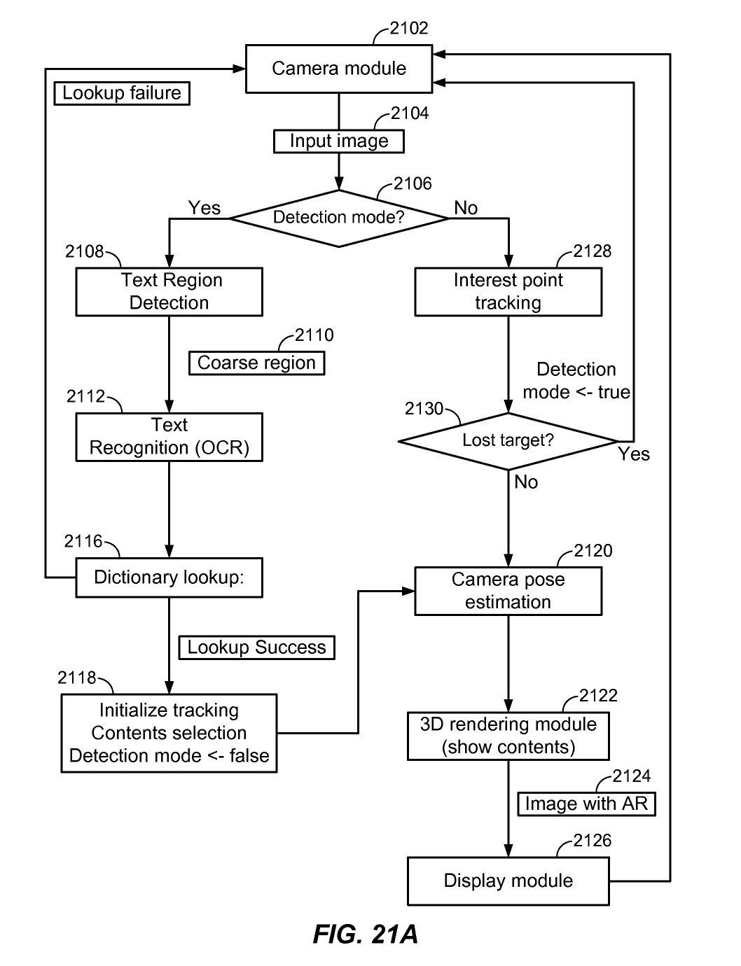

FIG. 18 is a flow diagram to illustrate a particular embodiment of a method 1800 of method of tracking text in image data. In a particular embodiment, the method 1800 may be performed by the image processing device 104 of FIG. 1A.

Image data may be received from an image capture device, at 1802. For example, the image capture device may include a video camera of a portable electronic device. To illustrate, video/image data 160 is received at the image processing device 104 from the image capture device 102 of FIG. 1A.

The image may include text. At least a portion of the image data may be processed to locate corner features of the text, at 1804. For example, the method 1800 may perform a corner identification method, such as is described with reference to FIG. 15, within a detected bounding box enclosing a text area to detect corners within the text.

In response to a count of the located corner features not satisfying a threshold, a first region of the image data may be processed, at 1806. The first region of the image data that is processed may include a first corner feature to locate additional salient features of the text. For example, the first region may be centered on the first corner feature and the first region may be processed by applying a filter to locate at least one of an edge and a contour within the first region, such as described with reference to the region 1512 of FIG. 15. Regions of the image data that include one or more of the located corner features may be iteratively processed until a count of the located additional salient features and the located corner features satisfies the threshold. In a particular embodiment, the located corner features and the located additional salient features are located within a first frame of the image data. The text in a second frame of the image data may be tracked based on the located corner features and the located additional salient features, such as described with reference to FIGS. 11-15. The terms “first” and “second” are used herein as labels to distinguish between elements without restricting the elements to any particular sequential order. For example, in some embodiments the second frame may immediately follow the first frame in the image data. In other embodiments the image data may include one or more other frames between the first frame and the second frame.

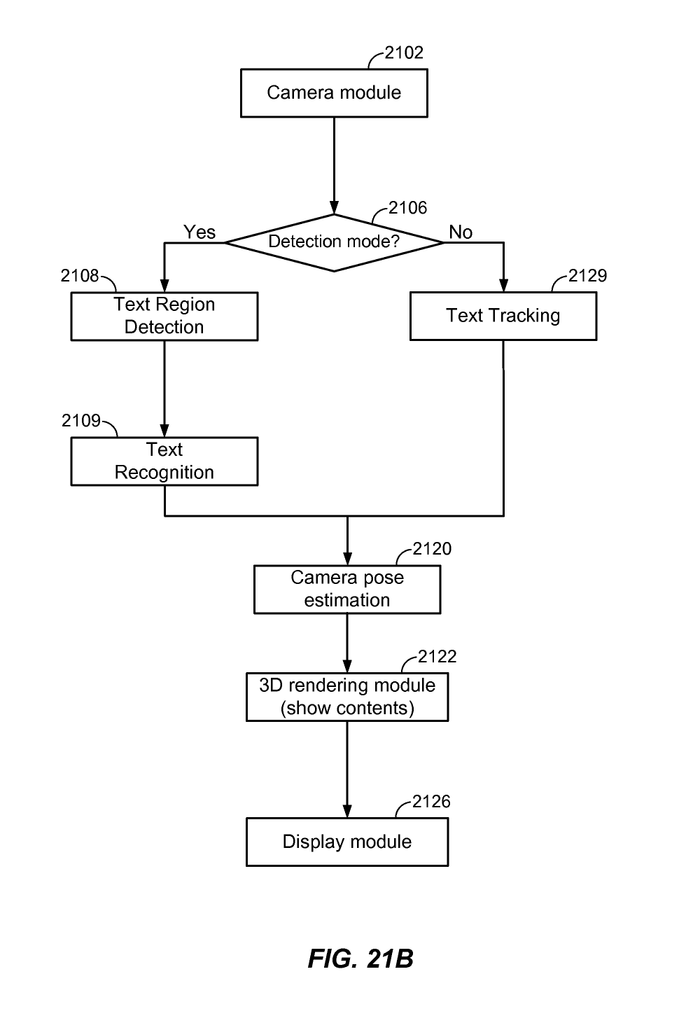

FIG. 19 is a flow diagram to illustrate a particular embodiment of a method 1900 of method of tracking text in image data. In a particular embodiment, the method 1900 may be performed by the image processing device 104 of FIG. 1A.

Image data may be received from an image capture device, at 1902. For example, the image capture device may include a video camera of a portable electronic device. To illustrate, video/image data 160 is received at the image processing device 104 from the image capture device 102 of FIG. 1A.

The image data may include text. A set of salient features of the text may be identified in a first frame of the image data, at 1904. For example, the set of salient features may include a first feature set and a second feature. Using FIG. 11 as an example, the set of features may correspond to the detected points of interest 1106-1110, the first feature set may correspond to the points of interest 1106, 1108, and 1110, and the second feature may correspond to the point of interest 1107 or 1109. The set of features may include corners of the text, as illustrated in FIG. 11, and may optionally include intersecting edges or contours of the text, such as described with reference to FIG. 15.

A mapping that corresponds to a displacement of the first feature set in a current frame of the image data as compared to the first feature set in the first frame may be identified, at 1906. To illustrate, the first feature set may be tracked using a tracking method, such as described with reference to FIGS. 11-15. Using FIG. 12 as an example, the current frame (e.g., image 1202 of FIG. 12) may correspond to a frame that is received some time after the first frame (e.g., image 1102 of FIG. 11) is received and that is processed by a text tracking module to track feature displacement between the two frames. Displacement of the first feature set may include the optical flows 1216, 1218, and 1220 indicating displacement of each of the features 1106, 1108, and 1110, respectively, of the first feature set.

In response to determining the mapping does not correspond to a displacement of the second feature in the current frame as compared to the second feature in the first frame, a region around a predicted location of the second feature in the current frame may be processed according to the mapping to determine whether the second feature is located within the region, at 1908. For example, the point of interest 1107 of FIG. 11 corresponds to an outlier because the mapping that maps points 1106, 1108, and 1110 to points 1206, 1208, and 1210, respectively, fails to map point 1107 to point 1207. Therefore, the region 1308 around the predicted location of the point 1107 according to the mapping may be processed using a window-matching technique, as described with respect to FIG. 13. In a particular embodiment, processing the region includes applying a similarity measure to compensate for at least one of a geometric deformation and an illumination change between the first frame (e.g., the key frame 1302 of FIG. 13) and the current frame (e.g., the current frame 1304 of FIG. 13). For example, the similarity measure may include a normalized cross-correlation. The mapping may be adjusted in response to locating the second feature within the region.

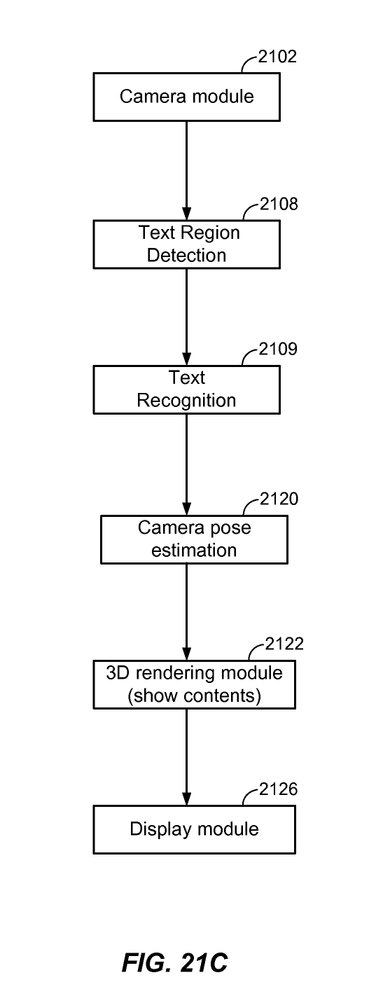

FIG. 20 is a flow diagram to illustrate a particular embodiment of a method 2000 of method of tracking text in image data. In a particular embodiment, the method 2000 may be performed by the image processing device 104 of FIG. 1A.

Image data may be received from an image capture device, at 2002. For example, the image capture device may include a video camera of a portable electronic device. To illustrate, video/image data 160 is received at the image processing device 104 from the image capture device 102 of FIG. 1A.

The image data may include text. A distorted bounding region enclosing at least a portion the text may be identified, at 2004. The distorted bounding region may at least partially correspond to a perspective distortion of a regular bounding region enclosing the portion of the text. For example, the bounding region may be identified using a method as described with reference to FIGS. 3-6. In a particular embodiment, identifying the distorted bounding region includes identifying pixels of the image data that correspond to the portion of the text and determining borders of the distorted bounding region to define a substantially smallest area that includes the identified pixels. For example, the regular bounding region may be rectangular and the borders of the distorted bounding region may form a quadrangle.

A pose of the image capture device may be determined based on the distorted bounding region and a focal length of the image capture device, at 2006. Augmented image data including at least one augmented reality feature to be displayed at a display device may be generated, at 2008. The at least one augmented reality feature may be positioned within the augmented image data according to the pose of the image capture device, such as described with reference to FIG. 16.

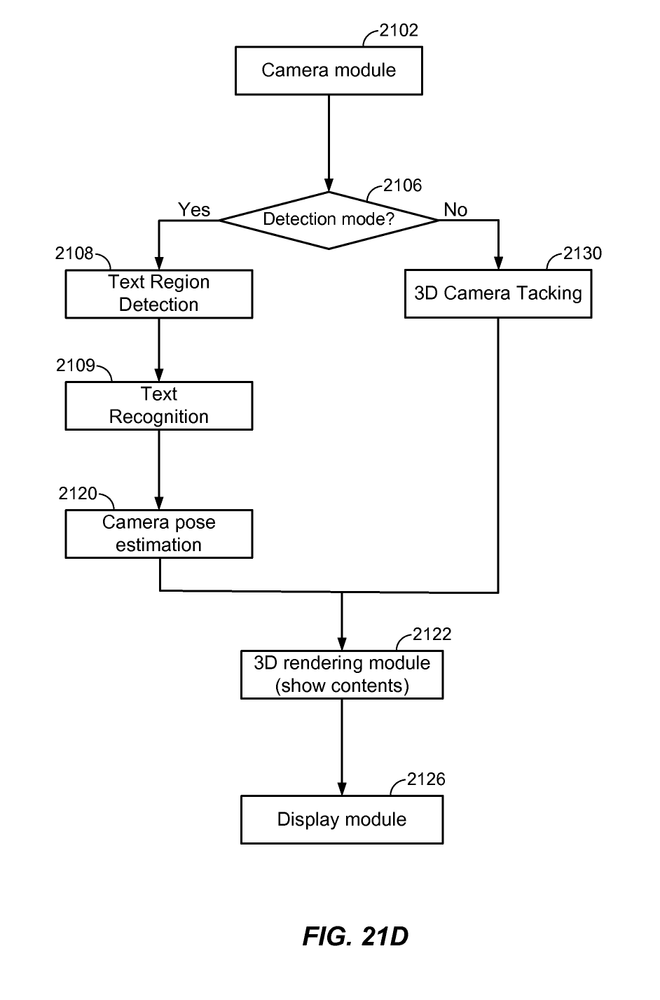

FIG. 21A is a flow diagram to illustrate a second particular embodiment of a method of providing text-based three-dimensional (3D) augmented reality (AR). In a particular embodiment, the method depicted in FIG. 21A includes determining a detection mode and may be performed by the image processing device 104 of FIG. 1B.

An input image 2104 is received from a camera module 2102. A determination is made whether a current processing mode is a detection mode, at 2106. In response to the current processing mode being the detection mode, text region detection is performed, at 2108, to determine a coarse text region 2110 of the input image 2104. For example, the text region detection may include binarization and projection profile analysis as described with respect to FIGS. 2-4.

Text recognition is performed, at 2112. For example, the text recognition can include optical character recognition (OCR) of perspective-rectified text, as described with respect to FIG. 8.

A dictionary lookup is performed, at 2116. For example, the dictionary lookup may be performed as described with respect to FIG. 9. In response to a lookup failure, the method depicted in FIG. 21A returns to processing a next image from the camera module 2102. To illustrate, a lookup failure may result when no word is found in the dictionary that exceeds a predetermined confidence threshold according to confidence data provided by an OCR engine.

In response to a lookup success, tracking is initialized, at 2118. AR content, such as translated text, 3D objects, pictures, or other content may be selected associated with the detected text. The current processing mode may transition from the detection mode (e.g., to a tracking mode).

A camera pose estimation is performed, at 2120. For example, the camera pose may be determined by tracking in-plane points of interest and text corners as well as out-of-plane points of interest, as described with respect to FIGS. 10-14. Camera pose and text region data may be provided to a rendering operation 2122 by a 3D rendering module to embed or otherwise add the AR content to the input image 2104 to generate an image with AR content 2124. The image with AR content 2124 is displayed via a display module, at 2126, and the method depicted in FIG. 21A returns to processing a next image from the camera module 2102.

When the current processing mode is not the detection mode when a subsequent image is received, at 2106, interest point tracking 2128 is performed. For example, the text region and other interest points may be tracked and motion data for the tracked interest points may be generated. A determination may be made whether the target text region has been lost, at 2130. For example, the text region may be lost when the text region exits the scene or is substantially occluded by one or more other objects. The text region may be lost when a number of tracking points maintaining correspondence between a key frame and a current frame is less than a threshold. For example, hybrid tracking may be performed as described with respect to FIG. 15 and window-matching may be used to locate tracking points that have lost correspondence, as described with respect to FIG. 13. When the number of tracking points falls below the threshold, the text region may be lost. When the text region is not lost, processing continues with camera pose estimation, at 2120. In response to the text region being lost, the current processing mode is set to the detection mode and the method depicted in FIG. 21A returns to processing a next image from the camera module 2102.

FIG. 21B is a flow diagram to illustrate a third particular embodiment of a method of providing text-based three-dimensional (3D) augmented reality (AR). In a particular embodiment, the method depicted in FIG. 21B may be performed by the image processing device 104 of FIG. 1B.

A camera module 2102 receives an input image and a determination is made whether a current processing mode is a detection mode, at 2106. In response to the current processing mode being the detection mode, text region detection is performed, at 2108, to determine a coarse text region of the input image. For example, the text region detection may include binarization and projection profile analysis as described with respect to FIGS. 2-4.

Text recognition is performed, at 2109. For example, the text recognition 2109 can include optical character recognition (OCR) of perspective-rectified text, as described with respect to FIG. 8, and a dictionary look-up, as described with respect to FIG. 9.

A camera pose estimation is performed, at 2120. For example, the camera pose may be determined by tracking in-plane points of interest and text corners as well as out-of-plane points of interest, as described with respect to FIGS. 10-14. Camera pose and text region data may be provided to a rendering operation 2122 by a 3D rendering module to embed or otherwise add the AR content to the input image to generate an image with AR content. The image with AR content is displayed via a display module, at 2126.

When the current processing mode is not the detection mode when a subsequent image is received, at 2106, text tracking 2129 is performed. Processing continues with camera pose estimation, at 2120.

FIG. 21C is a flow diagram to illustrate a fourth particular embodiment of a method of providing text-based three-dimensional (3D) augmented reality (AR). In a particular embodiment, the method depicted in FIG. 21C does not include a text tracking mode and may be performed by the image processing device 104 of FIG. 1C.

A camera module 2102 receives an input image and text region detection is performed, at 2108. As a result of text region detection at 2108, text recognition is performed, at 2109. For example, the text recognition 2109 can include optical character recognition (OCR) of perspective-rectified text, as described with respect to FIG. 8, and a dictionary look-up, as described with respect to FIG. 9.

Subsequent to the text recognition, a camera pose estimation is performed, at 2120. For example, the camera pose may be determined by tracking in-plane points of interest and text corners as well as out-of-plane points of interest, as described with respect to FIGS. 10-14. Camera pose and text region data may be provided to a rendering operation 2122 by a 3D rendering module to embed or otherwise add the AR content to the input image 2104 to generate an image with AR content. The image with AR content is displayed via a display module, at 2126.

FIG. 21D is a flow diagram to illustrate a fifth particular embodiment of a method of providing text-based three-dimensional (3D) augmented reality (AR). In a particular embodiment, the method depicted in FIG. 21D may be performed by the image processing device 104 of FIG. 1A.

A camera module 2102 receives an input image and a determination is made whether a current processing mode is a detection mode, at 2106. In response to the current processing mode being the detection mode, text region detection is performed, at 2108, to determine a coarse text region of the input image. As a result of text region detection 2108, text recognition is performed, at 2109. For example, the text recognition 2109 can include optical character recognition (OCR) of perspective-rectified text, as described with respect to FIG. 8, and a dictionary look-up, as described with respect to FIG. 9.

Subsequent to the text recognition, a camera pose estimation is performed, at 2120. For example, the camera pose may be determined by tracking in-plane points of interest and text corners as well as out-of-plane points of interest, as described with respect to FIGS. 10-14. Camera pose and text region data may be provided to a rendering operation 2122 by a 3D rendering module to embed or otherwise add the AR content to the input image 2104 to generate an image with AR content. The image with AR content is displayed via a display module, at 2126.

When the current processing mode is not the detection mode when a subsequent image is received, at 2106, 3D camera tracking 2130 is performed. Processing continues to rendering at the 3D rendering module, at 2122.

Those of skill would further appreciate that the various illustrative logical blocks, configurations, modules, circuits, and algorithm steps described in connection with the embodiments disclosed herein may be implemented as electronic hardware, computer software executed by a processing device such as a hardware processor, or combinations of both. Various illustrative components, blocks, configurations, modules, circuits, and steps have been described above generally in terms of their functionality. Whether such functionality is implemented as hardware or executable software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in a non-transitory storage medium such as random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or a user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method comprising:
receiving image data from an image capture device;
detecting text within the image data; and
in response to detecting the text, generating augmented image data that includes at least one augmented reality feature associated with the text.

2. The method of claim 1, wherein the text is detected without examining the image data to locate predetermined markers and without accessing a database of registered natural images.

3. The method of claim 1, wherein the image capture device comprises a video camera of a portable electronic device.

4. The method of claim 3, further comprising displaying the augmented image data at a display device of the portable electronic device.

5. The method of claim 1, wherein the image data corresponds to a frame of video data that includes the image data, and further comprising, in response to detecting the text, transitioning from a text detection mode to a tracking mode.

6. The method of claim 5, wherein a text region is tracked in the tracking mode relative to at least one other salient feature of the video data during multiple frames of the video data.

7. The method of claim 6, further comprising determining a pose of the image capture device, wherein the text region is tracked in three dimensions and wherein the augmented image data is positioned in the multiple frames according to a position of the text region and the pose.

8. The method of claim 1, wherein detecting the text includes estimating an orientation of a text region according to a projection profile analysis.

9. The method of claim 1, wherein detecting the text includes adjusting a text region to reduce a perspective distortion.

10. The method of claim 9, wherein adjusting the text region includes applying a transform that maps corners of a bounding box of the text region into corners of a rectangle.

11. The method of claim 9, wherein detecting the text includes:
generating proposed text data via optical character recognition; and
accessing a dictionary to verify the proposed text data.

12. The method of claim 11, wherein the proposed text data includes multiple text candidates and confidence data associated with the multiple text candidates, and wherein a text candidate corresponding to an entry of the dictionary is selected as verified text according to a confidence value associated with the text candidate.

13. The method of claim 1, wherein the at least one augmented reality feature is incorporated within the image data.

14. An apparatus comprising:
a text detector configured to detect text within image data received from an image capture device; and
a renderer configured to generate augmented image data, the augmented image data including augmented reality data to render at least one augmented reality feature associated with the text.

15. The apparatus of claim 14, wherein the text detector is configured to detect the text without examining the image data to locate predetermined markers and without accessing a database of registered natural images.

16. The apparatus of claim 14, further comprising the image capture device, wherein the image capture device comprises a video camera.

17. The apparatus of claim 16, further comprising:
a display device configured to display the augmented image data; and
a user input device, wherein the at least one augmented reality feature is a three-dimensional object and wherein the user input device enables user control of the three-dimensional object displayed at the display device.

18. The apparatus of claim 14, wherein the image data corresponds to a frame of video data that includes the image data, and wherein the apparatus is configured to transition from a text detection mode to a tracking mode in response to detecting the text.

19. The apparatus of claim 18, further comprising a tracking module configured to track a text region relative to at least one other salient feature of the video data during multiple frames of the video data while in the tracking mode.

20. The apparatus of claim 19, wherein the tracking module is further configured to determine a pose of the image capture device, wherein the text region is tracked in three dimensions and wherein the augmented image data is positioned in the multiple frames according to a position of the text region and the pose.

21. The apparatus of claim 14, wherein the text detector is configured to estimate an orientation of a text region according to a projection profile analysis.

22. The apparatus of claim 14, wherein the text detector is configured to adjust a text region to reduce a perspective distortion.

23. The apparatus of claim 22, wherein the text detector is configured to adjust the text region by applying a transform that maps corners of a bounding box of the text region into corners of a rectangle.

24. The apparatus of claim 22, wherein the text detector further comprises:
a text recognizer configured to generate proposed text data via optical character recognition; and
a text verifier configured to access a dictionary to verify the proposed text data.

25. The apparatus of claim 24, wherein the proposed text data includes multiple text candidates and confidence data associated with the multiple text candidates, and wherein the text verifier is configured to select as verified a text candidate corresponding to an entry of the dictionary according to a confidence value associated with the text candidate.

26. An apparatus comprising:
means for detecting text within image data received from an image capture device; and
means for generating augmented image data, the augmented image data including augmented reality data to render at least one augmented reality feature associated with the text.

27. A computer readable storage medium storing program instructions that are executable by a processor, the program instructions comprising:
code for detecting text within image data received from an image capture device; and
code for generating augmented image data, the augmented image data including augmented reality data to render at least one augmented reality feature associated with the text.

28. A method of tracking text in image data, the method comprising:
receiving image data from an image capture device, the image data including text;
processing at least a portion of the image data to locate corner features of the text; and
in response to a count of the located corner features not satisfying a threshold, processing a first region of the image data that includes a first corner feature to locate additional salient features of the text.

29. The method of claim 28, further comprising iteratively processing regions of the image data that include one or more of the located corner features until a count of the located additional salient features and the located corner features satisfies the threshold.

30. The method of claim 28, wherein the located corner features and the located additional salient features are located within a first frame of the image data, and further comprising tracking the text in a second frame of the image data based on the located corner features and the located additional salient features.

31. The method of claim 28, wherein the first region is centered on the first corner feature and wherein processing the first region includes applying a filter to locate at least one of an edge and a contour within the first region.

32. A method of tracking text in multiple frames of image data, the method comprising:
receiving image data from an image capture device, the image data including text;
identifying a set of features of the text in a first frame of the image data, the set of features including a first feature set and a second feature;
identifying a mapping that corresponds to a displacement of the first feature set in a current frame of the image data as compared to the first feature set in the first frame; and
in response to determining the mapping does not correspond to a displacement of the second feature in the current frame as compared to the second feature in the first frame, processing a region around a predicted location of the second feature in the current frame according to the mapping to determine whether the second feature is located within the region.

33. The method of claim 32, wherein processing the region includes applying a similarity measure to compensate for at least one of a geometric deformation and an illumination change between the first frame and the current frame.

34. The method of claim 33, wherein the similarity measure includes a normalized cross-correlation.

35. The method of claim 32, further comprising adjusting the mapping in response to locating the second feature within the region.

36. A method of estimating a pose of an image capture device, the method comprising:
receiving image data from the image capture device, the image data including text;
identifying a distorted bounding region enclosing at least a portion the text, the distorted bounding region at least partially corresponding to a perspective distortion of a regular bounding region enclosing the portion of the text;
determining a pose of the image capture device based on the distorted bounding region and a focal length of the image capture device; and
generating augmented image data including at least one augmented reality feature to be displayed at a display device, the at least one augmented reality feature positioned within the augmented image data according to the pose of the image capture device.

37. The method of claim 36, wherein identifying the distorted bounding region includes:
identifying pixels of the image data that correspond to the portion of the text; and
determining borders of the distorted bounding region to define a substantially smallest area that includes the identified pixels.

38. The method of claim 37, wherein the regular bounding region is rectangular and wherein the borders of the distorted bounding region form a quadrangle.
